(19) United States
(12) Patent Application Publication
(10) Pub. No.: US 2008/0101355 A1
(43) Pub. Date: May 1, 2008

(54) Transmission scheme dependent control of a frame buffer

(75) Inventors: Pasi Ojala, Kirkkonummi (FI); Ari Lakaniemi, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/607,479

(22) Filed: Nov. 30, 2006

Related U.S. Application Data
(63) Continuation-in-part of application No. 11/591,287, filed on Oct. 31, 2006.

(51) Int. Cl. H04L 12/56

(52) U.S. Cl. 370/389

(57) ABSTRACT

This invention relates to a method, a computer program product, apparatuses and a system for controlling a length of a frame buffer. The frame buffer is comprised in a receiver and buffers frames that are transmitted by a transmitter according to a frame transmission scheme and received at the receiver. The length of the frame buffer is controlled under consideration of a change in the frame transmission scheme.

### CROSS REFERENCE TO RELATED APPLICATION

This application is a continuation-in-part of U.S. patent application Ser. No. 11/591,287, filed on Oct. 31, 2006, from which domestic priority is claimed under 35 USC §120.

### FIELD OF THE INVENTION

This invention relates to a method, a computer program product, apparatuses and a system for controlling a length of a frame buffer.

### BACKGROUND OF THE INVENTION

Controlling a length of a frame buffer (corresponding to the control of the buffering time) is for instance of technical interest in the context of packet-switched transmission of speech data.

International publication WO 2006/044696 A1 discloses systems and methods for such a controlling of the length of a frame buffer. Therein, a receiver-side de-jitter buffer, which adds delay to received packets, adaptively adjusts its size based upon the detected air link characteristic, such that the de-jitter buffer is appropriately sized for anticipated data packets before they are received at the subscriber station.

A particular application area of packet-switched transmission of speech data are Voice over Internet Protocol (VoIP) systems. The packet-switched network transmission protocols typically employed for VoIP systems are the Real-time Transport Protocol (RTP, cf. IETF RFCs 3550 and 3551) on top of the User Datagram Protocol (UDP) on top of the Internet Protocol (IP). One or more speech frames, for instance obeying the Adaptive Multirate (AMR) codec or the AMR Wideband (AMR-WB) codec are encapsulated into RTP packets (IETF RFC 3267), which then form the payload of UDP packets, which in turn form the payload for IP packets. An example of such a VoIP application is the Internet Protocol Multimedia Subsystem (IMS) Multimedia Telephony standardized in the scope of the Third Generation Partnership Project (3GPP), cf. specification 3GPP TS 26.114.

The checksums employed in the UDP and IP layers result in discarding all the packets in which the receiver detects bit errors. Since these packets contain the frames, the protocol stack does thus not convey any distorted frames to the application layer of the protocol stack. Hence, when the IP packets are transmitted over an error prone radio link or over any media introducing transmission errors, the application layer faces frame losses. On the other hand, none of the frames reaching the application layer contain any residual bit errors. Due to this phenomenon, the error concealment algorithm is not able to utilize partially correct frames, as can be done e.g. in the circuit-switched GSM telephone service, but the erroneous frame needs to be completely replaced. This is likely to make the error concealment less effective than the approach used in circuit-switched service.

Various methods have been introduced to combat the packet loss conditions. There exist methods such as multiple description coding in which the information is distributed over several IP packets, and application level Forward Error Correction (FEC) in which the error correcting code is used to reconstruct the lost frames.

In addition, two comparably simple approaches can be utilized to fight frame loss: redundant frame transmission (also denoted as frame redundancy transmission) and frame aggregation transmission.

In redundant frame transmission, redundant copies of previously transmitted frames are transmitted together with the new frames, wherein the redundant frames are to be used in the receiver to replace frames carried in packets that were lost somewhere along the transmission path (note that this can be considered as a simple application level FEC). A packet thus contains one or more new frames and one or more redundant frames that have already been transmitted in previous frames.

In contrast, in frame aggregation transmission, several new frames are combined into one packet. This lowers the relative RTP/UDP/IP packet overhead, and hence the overall bit rate, which may decrease the error rate on a loaded (radio) link. Furthermore, when several frames are aggregated into a single packet, the packets are transmitted less frequently, which is likely to reduce congestion in the routers of an IP-based network.

Frame redundancy and frame aggregation can thus be understood to be defined by a frame transmission scheme that indicates which and how many frames are transmitted in an RTP packet.

One of the advantages of redundant transmission is the low computation requirement. It is applied by simply attaching the current and one or more previously transmitted frames within the same RTP packet. Decoding the redundant stream is also very straightforward: when a packet is lost, the receiver only needs to wait for the packet containing the redundant copy of the frame to arrive to convey it further to the decoder. Therein, it should be noted that a redundant copy of a specific frame does not necessarily have to be transmitted in the packet immediately following the packet in which said specific frame was transmitted. For instance, if interleaving with a depth of N packets is performed, where N is an integer, a frame and its redundant copy may be contained in a first and an N-th packet in a sequence of packets, respectively.

One drawback of frame redundancy is the increased bit rate. Basically, the bandwidth requirement is doubled when one redundant frame is attached to each transmitted packet. Furthermore, more importantly, the system delay is increased since the receiver needs to buffer the speech frames for the duration covered by the redundancy.

A similar delay issue is emerging in frame aggregation as well.

When changing the frame transmission scheme by switching on frame redundancy or frame aggregation in the transmitter, the receiver detects a delay step. For example, when switching from transmitting one frame per packet (which will be referred to as “normal transmission” in the following) into two frames per packet condition (either due to frame redundancy, where one of the frames is a new frame and one of the frames is a redundant frame, or due to frame aggregation, where both frames are new frames), an additional delay component of one frame length, typically an additional 20 ms, is introduced. Furthermore, if the redundant frame corresponds to a frame transmitted already N packets before (N>1), the additional delay is even N×20 ms.

This is due to the fact that, in case of switching from a normal transmission to a redundant transmission covering one frame, the receiver needs to increase the buffering time by the duration of a frame in order to allow the redundant frames to arrive in time for decoding. Consequently, when the redundant frame and its associated frame are not transmitted in subsequent packets, the buffering time increases even further.

In case of switching from a normal transmission to frame aggregation transmission with for instance two frames per packet, the transmitter needs to wait for one additional frame duration to collect another frame for packetization.

Thus in both cases, the receiver needs to wait for a certain time period before decoding the first packet after the change in the transmission scheme.

On the other hand, the decoder and playback devices being fed by the frame buffer require constant input, and therefore the gap introduced to the frame sequence by the change of the transmission scheme must be compensated. In the worst case, when the buffering time is set very short, the receiver may need to insert one or more error concealment frames for the decoder before the first aggregated or redundant frame packet arrives. This is likely to provide (short-term) speech quality degradation—although the actual purpose of the usage of frame redundancy of frame aggregation was to improve speech quality in challenging transmission conditions.

### SUMMARY

To combat the above-described speech quality degradations caused by changes in the transmission scheme, it may be considered to ensure that the length of the frame buffer at the receiver is large enough to cope with sudden delay increases. For example, a receiver buffer may require an additional headroom of one frame length (e.g. 20 ms) if change of the transmission scheme from normal transmission to frame redundancy transmission with 100% frame redundancy or from normal transmission to frame aggregation transmission with two frames per packet is expected to occur during a session.

However, since particularly in real-time applications such as conversational or streaming applications, delays are experienced as annoying and may aggravate proper communication, it is desirable that the buffer length is kept to a minimum.

A method is disclosed, comprising controlling a length of a frame buffer, which frame buffer is comprised in a receiver and buffers frames that are transmitted by a transmitter according to a frame transmission scheme and received at said receiver, under consideration of a change in said frame transmission scheme.

Moreover, a computer-readable medium having a computer program stored thereon is disclosed, the computer program comprising instructions operable to cause a processor to control a length of a frame buffer, which frame buffer is comprised in a receiver and buffers frames that are transmitted by a transmitter according to a frame transmission scheme and received at said receiver, under consideration of a change in said frame transmission scheme.

Therein, said computer-readable medium may be any medium that is capable of storing digital data in electric, magnetic, electro-magnetic or optic form. Said medium may be a separate medium, or may be integrated in said receiver. Said processor may be particularly dedicated for controlling said length of said buffer, or may be a processor that also performs other tasks, such as for instance a central processor of said receiver.

Therein, the invention is to be understood to cover such a computer program also independently from said computer-readable medium.

Moreover, an apparatus is disclosed, comprising a control unit, configured to control a length of a frame buffer, which frame buffer is comprised in a receiver and buffers frames that are transmitted by a transmitter according to a frame transmission scheme and received at said receiver, under consideration of a change in said frame transmission scheme.

Therein, said apparatus may for instance be a module for said receiver, or may be said receiver itself. Said apparatus may for instance be an electronic device with telephone functionality, such as for instance a mobile phone, a personal digital assistant or a computer.

Finally, a system is disclosed, comprising a transmitter, configured to transmit frames according to a frame transmission scheme; and a receiver, comprising a frame buffer configured to buffer said frames received from said transmitter; and a control unit configured to control a length of said frame buffer under consideration of a change in said frame transmission scheme. Said system may for instance be a communication system that implements VoIP, for instance via the IMS Multimedia Telephony service as standardized by 3GPP.

According to the present invention, a frame buffer is comprised in a receiver and buffers frames that are received from a transmitter, which transmits said frames according to said frame transmission scheme. A change in said frame transmission scheme may affect a required length of said frame buffer. To keep the length of the frame buffer at a minimum, and thus to reduce the delay encountered when extracting the frames from the frame buffer for further processing (e.g. decoding or rendering of the frames at a constant frame rate), it is advantageous that the length of the frame buffer is controlled under consideration of said change in said frame transmission scheme. Therein, the control of the length of said frame buffer does not only have to be based on said change of said transmission scheme. Said control may be based on additional parameters, such as for instance characteristics of a transmission network or link over which said frames are transmitted, as for instance the average or maximum transmission delay. Said control of said length of said frame buffer (corresponding to the buffering time) may for instance be handled by a buffer control unit by performing a frame insertion using error concealment or by causing a decoder that decodes said frames to perform time scaling to slow down the decoding and playback of the sequence of frames extracted from the frame buffer, and hence, increase the buffering time.

According to an exemplary embodiment of the present invention, said change in said frame transmission scheme is a future change. A length of said frame buffer is thus controlled under consideration of a future change in said frame transmission scheme, i.e. a change in said frame transmission scheme is anticipated at the receiver proactively. Being able to control the length of said frame buffer in advance, i.e. before an actual change in said transmission scheme occurs, has the advantage that the receiver may prepare for the consequences of said change in said transmission scheme and may compensate said consequences in due time. Furthermore, the receiver may have more degrees of freedom left in deciding when to compensate said consequences. For instance, if said change in said frame transmission scheme causes a temporal gap in the sequence of frames extracted from the frame buffer for decoding and/or playback, a buffer control algorithm at the receiver may be able to perform frame insertion or to cause a decoder to perform time scaling in a controlled manner during a specific period selected to minimize the subjective quality distortion, for instance a period of low signal or high noise.

Equally well, said change in said frame transmission may be a current or past change in said frame transmission scheme. Even if said change in said frame transmission scheme has already occurred, there may still be enough time to control the length of said frame buffer accordingly, for instance if said frames encounter large transmission delays.

According to an exemplary embodiment of the present invention, said change in said frame transmission scheme is commanded by said receiver. Said receiver may for instance send, to the transmitter, a command for a change in said frame transmission scheme (e.g. a media adaptation command). Therein, said command may for instance comprise information on the desired frame transmission scheme, the level of redundancy or the level of frame aggregation. Said transmitter may be obliged to obey the receiver's command and to change the transmission scheme accordingly. Said receiver thus has full knowledge that a change in the transmission scheme will occur.

According to an exemplary embodiment of the present invention, said change in said frame transmission scheme is requested by said receiver. Said receiver may for instance send, to the transmitter, a request for a change in said frame transmission scheme (e.g. a media adaptation request). Therein, said request may for instance comprise information on the desired frame transmission scheme, the level of redundancy or the level of frame aggregation. Said transmitter may not be obliged to fully satisfy said request, i.e. it may not perform any changes in said frame transmission scheme at all, may only partially change said frame transmission scheme, or may change said frame transmission scheme to an extent that exceeds the receiver's request. According to this embodiment, said receiver thus has at least implicit knowledge that a change in the transmission scheme might occur, so that, to avoid loss of frames or unexpected gaps in the frame sequence extracted from the frame buffer, it is advantageous to control the length of the buffer as if said change in said frame transmission scheme was for sure.

According to an exemplary embodiment of the present invention, a necessity of said change in said frame transmission scheme is determined by said transmitter at least partially based on measurement data provided by said receiver. Said measurement data may for instance be related to the packet loss rate or to jitter conditions. Said measurement data may for instance be transmitted via RTCP receiver reports. When the receiver applies the same algorithm as the transmitter to decide if, based on the measurement data, a change of the transmission scheme is required, the receiver is enabled to anticipate the change of the transmission scheme by the transmitter. Alternatively, said transmitter may determine a necessity for said change in said frame transmission scheme due to a handover to another access technology with different transmission characteristics and/or due to a change in the available bandwidth.

According to an exemplary embodiment of the present invention, said controlling comprises at least one of frame insertion and time scaling. When changing from normal transmission to frame aggregation transmission or to frame redundancy transmission, the frame buffer length has to be increased by one or more frame durations. This means that extraction of frames for decoding and rendering (e.g. playback) from the frame buffer is also delayed by said one or more frame durations, so that, when considering the situation before the change in the frame transmission scheme and after the change in the frame transmission scheme, there exists a temporal gap in the sequence of frames extracted from the frame buffer. This gap may for instance be handled by inserting an error concealment frame into the sequence of frames extracted from the frame buffer to fill the gap, wherein said error concealment frame may for instance be a copy of the temporally preceding or following frame or a function thereof. Alternatively, or additionally, the decoder may be triggered to perform time scaling in order to control the length of the frame buffer. Therein, time scaling is performed with the signals contained in the frames extracted from the frame buffer. For instance, if the signals are stretched in the decoder, a subsequent rendering unit (e.g. a playback unit) gets more data and thus requires less frames within a given period of time, so that the decoder needs to extract frames from the frame buffer less frequently. Consequently, the buffer occupancy is increased since the output of frames is now slower than the input, i.e. the length of the frame buffer is increased. If the frames are shrunk in the decoder, the rendering unit gets less data and thus requires more frames within a given period of time, so that the decoder needs to extract frames from the frame buffer more frequently. Consequently, the buffer occupancy is decreased, i.e. the length of the frame buffer is reduced.

Therein, time scaling may allow a continuous and smooth concealment of the gap, whereas frame insertion may only allow an abrupt concealment of the gap. It may thus be advantageous if said inserted error concealment frame is surrounded by frames that only contain background/comfort noise or only a low or no audio signal at all. By time scaling and frame insertion, thus the gap in the sequence of frames may be concealed without excessively compromising the quality of the further processing of said sequence of frames.

According to an exemplary embodiment of the present invention, furthermore controlling of a minimum length of said frame buffer under consideration of said change in said frame transmission scheme is performed.

Therein, said minimum length of said frame buffer corresponds to the minimum time for which a frame has to be buffered in said frame buffer. Furthermore, a maximum length of said frame buffer may be defined, and control of said length of said frame buffer then may be performed within the limits of said minimum and maximum lengths of said frame buffer. In addition to said change-of-frame-transmission-scheme dependent control of said length of said frame buffer (i.e. said control of said length of said frame buffer under consideration of said change in said frame transmission scheme), said frame buffer may further be controlled (e.g. by a buffer manager) to minimize frame delay. Said control of said minimum length of said frame buffer may then prevent that said control of said length of said frame buffer that targets minimization of the frame delay interferes with said change-of-frame-transmission-scheme dependent control of said length of said frame buffer. For instance, if the minimum length of said frame buffer and the length of the frame buffer are increased by the same amount due to the consideration of a change in said frame transmission scheme, the exemplary case may be avoided that, after an increase of said length of said frame buffer under consideration of said change in said frame transmission scheme has taken place, the length of said frame buffer would be reduced again based on said delay-minimization based control, because such a reduction is forbidden according to the increased minimum length of said frame buffer. Without controlling also the minimum length of said frame buffer, the control of the length of said frame buffer under consideration of said change in said frame transmission scheme might have no or only partial effect.

In this exemplary embodiment of the present invention, said minimum length of said frame buffer may be controlled by changing said minimum length of said frame buffer by an amount that corresponds to a delay imposed by said change in said frame transmission scheme. Said amount may for instance be the same amount by which said length of said frame buffer is changed.

In this exemplary embodiment of the present invention, a change of said minimum length of said frame buffer due to said control of said minimum length of said frame buffer is maintained until said frame transmission scheme has changed. After said change of said frame transmission scheme, said minimum length of said frame buffer may be changed again, for instance to be set back to its former value, which may for instance account for the current or average network delay jitter.

According to an exemplary embodiment of the present invention, said frame transmission scheme defines which and how many frames are transmitted in a packet of a transport protocol. A change of said transmission scheme may then for instance occur when the number of frames transmitted in a packet is changed, and/or when a rule defining which frames are transmitted in a packet is changed.

According to an exemplary embodiment of the present invention, said transmission scheme is suited to define at least one of frame aggregation transmission and frame redundancy transmission. In frame aggregation transmission, a plurality of frames that not yet have been transmitted are transmitted in a packet. In frame redundancy transmission, at least one frame that has not been transmitted before and at least one frame that has been transmitted before are transmitted in a packet. A change of said transmission scheme may then for instance occur when a normal transmission, in which one frame is transmitted in a packet, is changed to a frame aggregation transmission, or is changed to a frame redundancy transmission. Moreover, a change of said transmission scheme may for instance occur when in a frame aggregation transmission, the number of frames transmitted in a packet is changed. Furthermore, a change of said transmission scheme may for instance occur when in a frame redundancy transmission, at least one of the number of frames that has already been transmitted and the number of frames that has not yet been transmitted is changed.

According to an exemplary embodiment of the present invention, said frames are speech frames. Said speech frames may for instance obey the AMR or AMR-WB codec.

According to an exemplary embodiment of the present invention, said frames are encapsulated into real-time transport protocol frames. Said RTP frames may in turn be encapsulated into UDP frames, which in turn may be encapsulated into IP frames.

According to an exemplary embodiment of the present invention, said frames are transmitted via an IP-based network.

According to an exemplary embodiment of the present invention, said receiver is a multimedia telephony service over internet protocol multimedia subsystem receiver.

These and other aspects of the invention will be apparent from and elucidated with reference to the embodiments described hereinafter.

### BRIEF DESCRIPTION OF THE FIGURES

In the figures show:

FIG. 1: a schematic block diagram of an exemplary embodiment of a system according to the present invention

FIG. 2a: a flowchart of an exemplary receiver processing according to the present invention;

FIG. 2b: a flowchart of an exemplary transmitter processing according to the present invention complementing the receiver processing of FIG. 2a;

FIG. 3a: a further flowchart of an exemplary receiver processing according to the present invention;

FIG. 3b: a flowchart of an exemplary transmitter processing according to the present invention complementing the receiver processing of FIG. 3a;

FIG. 4a: a further flowchart of an exemplary receiver processing according to the present invention; and

FIG. 4b: a flowchart of an exemplary transmitter processing according to the present invention complementing the receiver processing of FIG. 4a.

### DETAILED DESCRIPTION OF THE INVENTION

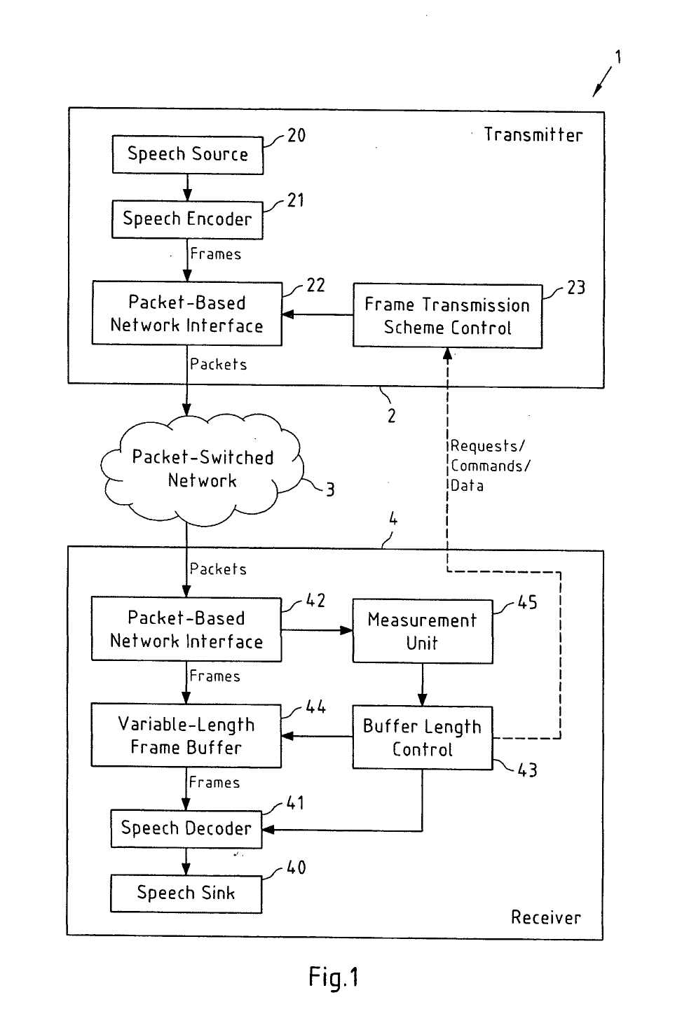

FIG. 1 is a schematic block diagram of an exemplary embodiment of a system 1 according to the present invention. Said system 1 may for instance be a VoIP system, in particular a Multimedia Telephony Service over IMS (MTSI) system as standardized by 3GPP. System 1 comprises a transmitter 2, a packet-switched network 3 and a receiver 4. It is readily understood that system 1 may comprise more than one transmitter and more than one receiver.

In transmitter 2, speech from a speech source 20, such as for instance a microphone, is encoded in speech encoder 21. Speech encoder 21 may for instance implement the AMR or AMR-WB standard and outputs frames of digital data, which are transmitted over the packet-switched network 3 via the packet-switched network interface 22. For instance, said packet-switched network may be an IP-based network. Then, in the packet-switched network interface 22, the frames may be encapsulated into RTP packets, which in turn are encapsulated into UDP packets, which in turn are encapsulated into IP packets to be routed through the network 3.

The packetization of the frames into packets is, inter alia, defined by a frame transmission scheme defining which and how many frames are transmitted in a single packet. In a normal frame transmission, for instance one frame may be transmitted in one packet. However, to account for packet losses in the packet-switched network 3, it may be advantageous to include more than one frame into a packet. For instance, in case of frame redundancy transmission, at least one frame that has not yet been transmitted and at least one redundant frame that has already been transmitted before are transmitted in one packet. In case of frame aggregation transmission, more than one frame are transmitted in a single packet (without redundant frames), in order to reduce protocol overhead and thus to decrease the overall bit rate, which may decrease the error rate on a loaded link and may reduce congestions in the routers of the packet-switched network 3.

To account for varying transmission characteristics of the packet-switched network, which may for instance be caused by radio links within the packet-based network 3, the transmission scheme applied in packet-based network interface 3 can be changed by frame transmission scheme control unit 23. For instance, the frame transmission scheme may be changed by changing the number of frames that are aggregated into a single packet, or by switching from normal transmission to redundant transmission, or by changing the number of redundant frames per packet, to name but a few possibilities.

Receiver 4 comprises a packet-based network interface 42, where packets received from network 3 are processed to recover the frames encapsulated therein. For instance, if packet-switched network interface 22 in transmitter 2 uses an RTP/UDP/IP protocol stack for encapsulation, also packet-based network interface 42 may use a corresponding RTP/UDP/IP protocol stack for recovering the frames.

The frames as output by the packet-based network interface 42 generally do not arrive at a constant frame rate due to varying transmission delays of each frame in the packet-switched network 3. This delay jitter is compensated for by a frame buffer, which, according to the present invention, is a variable-length frame buffer 44. Frames buffered in frame buffer 44 may be read out from buffer 44 at a constant frame rate to be processed by speech decoder 41, and the decoded speech is then forwarded to speech sink 40, which may for instance be a loudspeaker.

Frame buffer 44 is of variable length to allow that the buffer length may always be kept down to a minimum. Since the buffering in frame buffer 44 adds an additional delay to each frame, and since delays are considered annoying particularly in conversational or streaming applications, it is highly desirable to keep this additional delay as small as possible. On the other hand, in case of deteriorating transmission characteristics of the packet-switched network, it may become inevitable to change the transmission scheme at the transmitter to avoid packet loss. For instance, in case of packet loss in the packet-switched network, it may be inevitable to switch from normal transmission to frame redundancy transmission or to frame aggregation transmission. Both mentioned changes in the frame transmission scheme require an increased length of frame buffer 44. For instance, if the transmission scheme is switched from normal transmission to frame aggregation transmission with e.g. two frames per packet, the packet-based network interface 22 at transmitter 22 has to wait for an additional frame length (of the second frame in the packet) before the packetization can be finished. Thus, compared to normal transmission, the length of frame buffer 42 has to be increased by an additional frame length. Similarly, if the transmission scheme is switched from normal transmission to frame redundancy transmission with e.g. one redundant frame and one non-redundant frame per packet, wherein the redundant frame is associated with a frame in the directly previous packet, the length of frame buffer 42, compared to the case of normal transmission, has to be increased by one frame length to allow that also the redundant frame arrives in time for decoding (and can be considered for decoding).

To this end, the length of frame buffer 42 is controlled by buffer length control unit 43 under consideration of a change in the frame transmission scheme at transmitter 2. This control of the frame buffer length may be most effective if said change of said transmission scheme has not yet occurred, i.e. if said change is a future change. It is then possible to adapt the present buffer length to the desired new buffer length in a controlled manner, for instance in a way that minimizes the subjective quality distortion (e.g. of the media playback). This adaptation may for instance be performed by buffer length control unit 43 by means of insertion of an error concealment frame into the stream of frames extracted from frame buffer 44. Alternatively, the buffer length control unit 43 may adapt the length of frame buffer 44 by sending a time scaling command to speech decoder 41, as indicated by the arrow between buffer length control unit 43 and speech decoder 41.

Speech Decoder 41 then performs time scaling during or after decoding of the frames extracted from frame buffer 44, wherein time scaling is performed with the speech signals represented by the frames in the following manner: If the signals are stretched in speech decoder 41, speech sink 40 gets more data and thus requires less frames within a given period of time, so that speech decoder 41 needs to extract frames from frame buffer 44 less frequently. Consequently, the buffer occupancy is increased since the output of frames is now slower than the input, i.e. the length of frame buffer 44 is increased. If the frames are shrunk in speech decoder 41, speech sink 40 gets less data and thus requires more frames within a given period of time, so that speech decoder 41 needs to extract frames from frame buffer 44 more frequently. Consequently, the buffer occupancy is decreased, i.e. the length of frame buffer 44 is reduced.

Both frame insertion and time scaling thus allow to slow down decoding and playback of the sequence of frames extracted from the frame buffer and thus allow to increase the buffering time in case of additional delays. Therein, time scaling may allow to adapt the length of the frames from the decoder 41 in a continuous way, whereas frame insertion may be used for an abrupt adaptation of the frame buffer length.

Receiver 4 can be enabled to anticipate changes of the frame transmission scheme by transmitter 2 in a variety of ways. In the following, three exemplary embodiments will be discussed, in which the transmission performance of the packet-switched network 3 is measured by means of the measurement unit 45 in receiver 4 and used as a basis for the decision if a change in the frame transmission scheme at transmitter 2 is required or not.

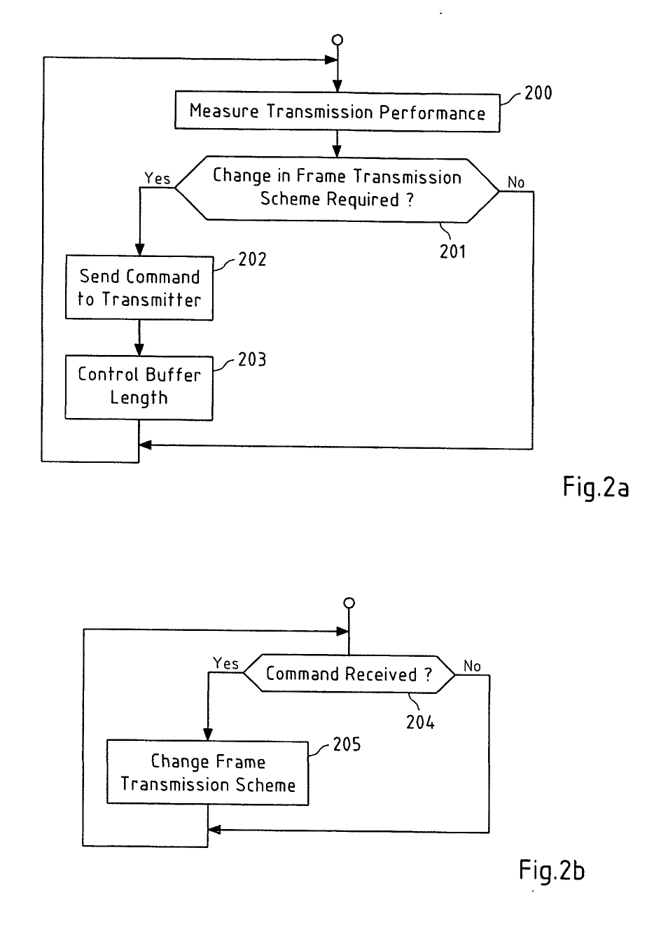

According to a first embodiment, which is depicted in the flowcharts of FIGS. 2a and 2b, relating to the processing at receiver 4 and transmitter 2 (see FIG. 1), respectively, receiver 4 measures the transmission performance of the packet-switched network 3 in a step 200, for instance in terms of packet loss rate and jitter. Based on these measurements, receiver 4 decides, in a step 201, if a change in the frame transmission scheme at transmitter 2 is required. If this is the case, a command for a change in the frame transmission scheme is sent to transmitter 2 in a step 202. This command may for instance contain control information related for example to the desired frame transmission scheme, the number of redundant frames in frame redundancy transmission or the number of frames in frame aggregation transmission, to name but a few. Said command may for instance be a media adaptation command that further includes control information related to the codec mode (e.g. AMR/AMR-WB). The transmission of this command, which is illustrated in FIG. 1 as a dashed line between buffer length control unit 43 and frame transmission scheme control unit 23, may be in-band (e.g. included in the media stream in the reverse direction) or out-of-band (e.g. as separate signaling packets). Since receiver 4 knows that transmitter 2 will obey the command for change in the frame transmission scheme transmitted in step 202, the buffer length can now be controlled by buffer length control unit 43 of receiver 4 in a step 203 to anticipate the forthcoming change in the frame transmission scheme. The flowchart of FIG. 2a then jumps back to step 200 and performs an anew measurement of the transmission performance of network 3, thus to be able to proactively react to further variations in transmission performance that may require a change in the frame transmission scheme. In this way, it is ensured that the length of frame buffer 44 is always optimal. If the transmission performance of network 3 deteriorates, receiver 4 triggers a change in the frame transmission scheme, for instance by commanding that frame redundancy transmission is used, and accordingly increases the length of frame buffer 44. If, after a while, the transmission performance of network 33 improves, receiver 4 triggers a further change in the frame transmission scheme, for instance be commanding that the frame transmission scheme is changed from frame redundancy transmission to normal transmission, and reduces the length of frame buffer 44 accordingly.

The corresponding processing at transmitter 2 is illustrated in the flowchart of FIG. 2b. As soon as a command from receiver 4 is received, which is continuously checked in step 204, the frame transmission scheme is changed by frame transmission scheme control unit 23 of transmitter 2 in a step 205. The flowchart then jumps back to step 204 to wait for further commands.

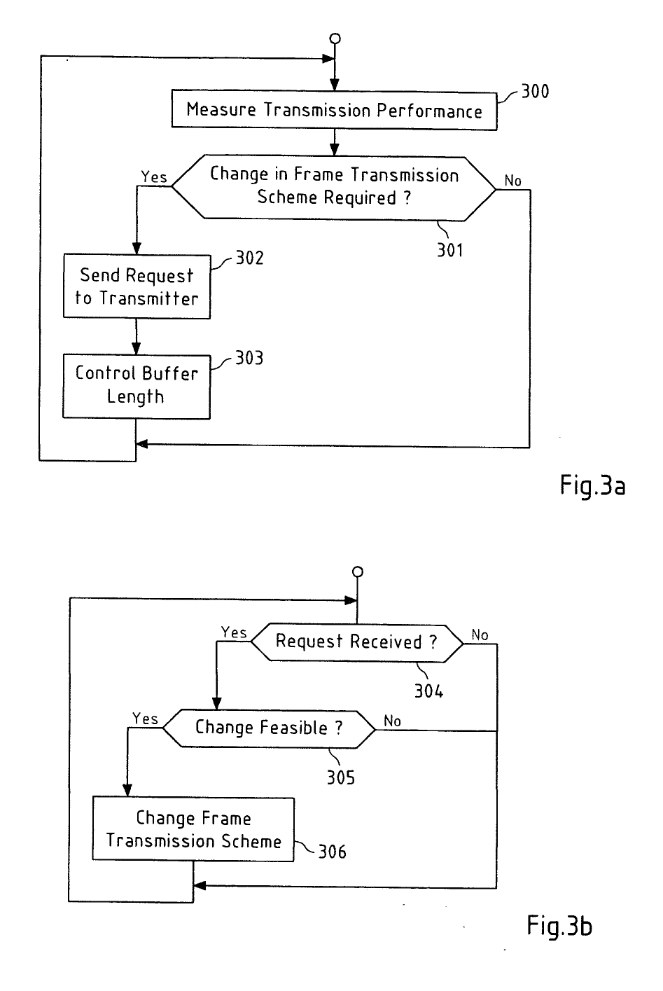

According to a second embodiment, which is depicted in the flowcharts of FIGS. 3a and 3b, relating to the processing at receiver 4 and transmitter 2 (see FIG. 1), respectively, receiver 4 once again measures the transmission performance of the packet-switched network 3 in a step 300. Based on these measurements, receiver 4 decides, in a step 301, if a change in the frame transmission scheme at transmitter 2 is required. However, instead of sending a command to transmitter 2, as it was the case in step 202 of the flowchart in FIG. 2a, buffer length control unit 43 now sends a request to change the frame transmission scheme to frame transmission scheme control unit 23 of transmitter 2 in a step 302. This request may contain control information as already described above with respect to the previous embodiment. Said request may for instance be a media adaptation request that further includes control information related to the codec mode (e.g. AMR/AMR-WB). In contrast to the command, the request leaves transmitter 2 some flexibility in deciding if such a change in the frame transmission scheme is feasible or not. Subsequently, in a step 303, the length of frame buffer 44 is controlled by buffer length control unit 43 according to the request sent to transmitter 2, and the flowchart jumps back to step 300.

The flowchart of FIG. 3b illustrates the corresponding processing in frame transmission control unit 23 of transmitter 2. Upon reception of the request, which is checked for in a step 304, it is determined if the request for a change in the frame transmission scheme is feasible. For instance, the number of redundant frames per packet requested by receiver 4 in its request may be too large, so that the transmitter 2 decides to change the frame transmission scheme only in a way that frame redundancy transmission with less redundant frames is performed. The flowchart of FIG. 3b then returns to step 304 to check for further requests.

It should be noted that the effect of the fact that transmitter 2 did not completely satisfy the request of receiver 4 with respect to the requested number of redundant frames is that receiver 4, expecting that its request will possibly be fully met, sets out from a larger required buffer length than it is actually required, so that the delay of the frame buffer 44 will be controlled to a too large value. However, this situation may be quickly cured by prescribing that transmitter 2, when not fully satisfying the receiver's request for a change of the transmission scheme, informs receiver 4 accordingly, so that the length of frame buffer 44 can be reduced accordingly. However, it is apparent that this embodiment, despite the possible overshooting of the frame buffer length, nevertheless allows to avoid that frames are lost due to a change in the frame transmission scheme and to adapt the length of the frame buffer to the required length in a controlled manner.

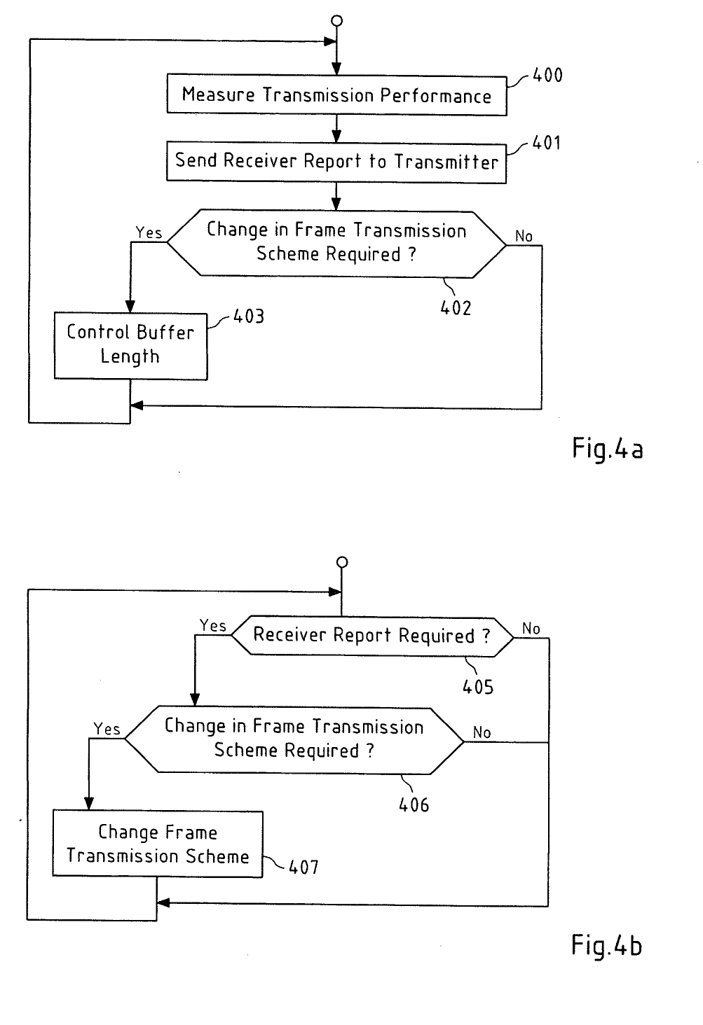

According to a third embodiment, which is depicted in the flowcharts of FIGS. 4a and 4b, relating to the processing at receiver 4 and transmitter 2 (see FIG. 1), respectively, receiver 4 once again measures the transmission performance of the packet-switched network 3 in a step 400. In a step 401, the measured data is directly transmitted to transmitter 2, for instance in the form of RTCP receiver reports. This may be performed by the buffer length control unit 43 (as illustrated by the dashed line in FIG. 1), or by the measurement unit 45 itself. In a step 402, the buffer length control unit 43 nevertheless determines if a change in the frame transmission scheme is required or not, and, if this should be the case, controls the length of frame buffer 44 accordingly in a step 403. The flowchart then returns to step 400. The rationale behind this approach is that it is assumed that both transmitter 2 and receiver 4 use the same algorithm or a similar algorithm for determining whether a change in the frame transmission scheme is required, wherein said algorithm is used by receiver 4 in step 401 and by transmitter 2 in step 406 (see description below). Thus based on the same set of measurement data, both transmitter 2 and receiver 4 will come to the same decision, so that the receiver 4 can anticipate the change in the frame transmission scheme when performing the control of the length of the frame buffer in step 403.

The flowchart of FIG. 4b illustrates the corresponding processing in frame transmission control unit 23 of transmitter 2. Upon reception of a receiver report, which is checked in a step 405, it is determined if a change in the frame transmission scheme is required in a step 406.

Therein, for determining whether said change in said frame transmission scheme is required, transmitter 2 deploys e.g. the same or a similar algorithm than the algorithm that is used by receiver 4 in step 402 in the flowchart of FIG. 4a. If it is determined that a change in the frame transmission scheme is required, the frame transmission scheme is changed in a step 407. The flowchart then jumps back to step 405.

In the three embodiments described above, the change in the frame transmission scheme at the transmitter was at least partially based on measurements of the transmission performance of the packet-switched network 3, wherein the measurements were performed by measurement unit 45 of receiver 4. It should however be noted that transmitter 2 may equally well come to the decision to change the transmission scheme without requiring measurement data from receiver 4. For instance, said frame transmission scheme may be changed by transmitter 2 due to a handover to another access technology with different transmission characteristics, or due to a change in the available channel bandwidth. In such cases, receiver 4 may nevertheless gain knowledge of the change in the frame transmission scheme and control the length of the frame buffer accordingly. Furthermore, said change may still be a future change, i.e. receiver 4 may gain this knowledge before the change occurs, so that there is enough time to take care that the adaptation of the buffer length is performed in a controlled manner. For instance, transmitter 2 may inform receiver 4 of a forthcoming change in the transmission scheme by in-band or out-of-band signaling, or receiver 4 and transmitter 2 may be configured to analyze the same parameters that trigger a change in the frame transmission scheme, so that, when transmitter 2 comes to the conclusion that a change in the frame transmission scheme has to be performed, also receiver 4 comes to this conclusion.

In the embodiments described with reference to FIGS. 1 to 4b, it was exemplarily assumed that buffer length control unit 43 controls the length of frame buffer 44 under consideration of a change in the frame transmission scheme at transmitter 2.

According to a further exemplary embodiment of the present invention, buffer length control unit 43 additionally adopts functionality of a buffer manager and performs overall delay performance optimization to minimize the required buffer length (i.e. the required buffering time). Therein, buffer length control unit 43 applies minimum and maximum limits for the length of frame buffer 44, within which control of the length of frame buffer 44 takes place. It may be beneficial to set the minimum length of frame buffer 44 as low as possible while taking into account the possible delay increase (jitter) in the packet-switched network 3. On the other hand, the maximum length of frame buffer 44 may be set to avoid too extensive an increase of the length of frame buffer 44 in case of bad transmission conditions. The maximum length of frame buffer 44 may typically be set based on the knowledge on the acceptable end-to-end delay in conversational services, and the delay budget share for the frame buffer 44.

However, when setting the minimum length of frame buffer 44 based on the measured network jitter (i.e. when setting the minimum length of frame buffer 44 to cover the network jitter), a conflict between the control of the length of frame buffer 44 under consideration of a change in the frame transmission scheme on the one hand and the control of the length of frame buffer 44 in order to minimize the overall delay on the other hand may occur. For instance, if buffer length control unit 43 has increased the length of frame buffer 44 due to a forthcoming change in the frame transmission scheme at transmitter 2, the overall delay performance optimization of buffer control unit 43 may interfere by considering the increased length of frame buffer 44 unnecessary and may for instance perform time scaling operations to reduce the length of frame buffer 44. In this case, the benefit of controlling the length of frame buffer 44 under consideration of a (future) change of the frame transmission scheme in order to avoid gaps in the sequence of frames extracted from frame buffer 44 would be lost.

To avoid such conflicts, buffer length control unit 43 is further configured to control the minimum length of frame buffer 44 under consideration of changes in the frame transmission scheme at transmitter 2. Thus when buffer length control unit 43 prepares for the increased transmission delay of redundant or aggregated transmission by increasing the length of buffer length 44 proactively, also the minimum length of frame buffer 44 is increased, for instance by the same amount as the length of frame buffer 44. This maintains the “headroom” in frame buffer 44 until change of the transmission scheme has occurred, and prevents the overall delay performance optimization to cancel the effort made when proactively increasing the length of frame buffer 44 due to forthcoming changes in the frame transmission scheme at transmitter 2. In the flowcharts of FIGS. 2a, 3a and 4a control of the minimum buffer length may for instance be performed together with the control of the buffer length, i.e. in steps 203, 303 and 403, respectively.

The modified minimum length of frame buffer 44 is advantageously maintained until the change of the frame transmission scheme and the associated media transport adaptation (i.e. the additional transport delay due to frame aggregation and/or redundant frame transmission) has occurred. After the change has been detected, buffer length control unit 43 may revert to the former minimum length of frame buffer 44.

Receiver 4 may for instance comprise a state machine which is in the “increased buffer length state” when the change in transmission scheme is desired or expected and moves back to “normal buffer length state” when a new transmission scheme is detected.

Since the delay requirement for conversational services still holds when the transmission scheme is changed, the maximum length of frame buffer 44 may not need to be modified in this process.

The control of the minimum length of frame buffer 44 under consideration of a change in the frame transmission scheme at transmitter 2, may be implemented in buffer length control unit 43, as described above, but may equally well be implemented in a further unit.

It is readily clear for a skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. Said computer software may be stored in a variety of storage media of electric, magnetic, electro-magnetic or optic type and may be read and executed by a processor, such as for instance a microprocessor. To this end, said processor and said storage medium may be coupled to interchange information, or the storage medium may be included in the processor.

The invention has been described above by means of exemplary embodiments. It should be noted that there are alternative ways and variations which are obvious to a skilled person in the art and can be implemented without deviating from the scope and spirit of the appended claims. In particular, the present invention is not limited to application in VoIP systems and/or to transmission of speech or audio frames.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method, comprising:
controlling a length of a frame buffer, which frame buffer is comprised in a receiver and buffers frames that are transmitted by a transmitter according to a frame transmission scheme and received at said receiver, under consideration of a change in said frame transmission scheme.

2. The method according to claim 1, wherein said change in said frame transmission scheme is a future change.

3. The method according to claim 1, wherein said change in said frame transmission scheme is commanded by said receiver.

4. The method according to claim 1, wherein said change in said frame transmission scheme is requested by said receiver.

5. The method according to claim 1, wherein a necessity of said change in said frame transmission scheme is determined by said transmitter at least partially based on measurement data provided by said receiver.

6. The method according to claim 1, wherein said controlling comprises at least one of frame insertion and time scaling.

7. The method according to claim 1, further comprising:
controlling a minimum length of said frame buffer under consideration of said change in said frame transmission scheme.

8. The method according to claim 7, wherein said minimum length of said frame buffer is controlled by changing said minimum length of said frame buffer by an amount that corresponds to a delay imposed by said change in said frame transmission scheme.

9. The method according to claim 7, wherein a change of said minimum length of said frame buffer due to said control of said minimum length of said frame buffer is maintained until said frame transmission scheme has changed.

10. The method according to claim 1, wherein said frame transmission scheme defines which and how many frames are transmitted in a packet of a transport protocol.

11. The method according to claim 1, wherein said transmission scheme is suited to define at least one of frame aggregation transmission and frame redundancy transmission.

12. The method according to claim 1, wherein said frames are speech frames.

13. The method according to claim 1, wherein said frames are encapsulated into real-time transport protocol frames.

14. The method according to claim 1, wherein said frames are transmitted via an internet protocol-based network.

15. The method according to claim 1, wherein said receiver is a multimedia telephony service over internet protocol multimedia subsystem receiver.

16. A computer-readable medium having a computer program stored thereon, the computer program comprising:
instructions operable to cause a processor to control a length of a frame buffer, which frame buffer is comprised in a receiver and buffers frames that are transmitted by a transmitter according to a frame transmission scheme and received at said receiver, under consideration of a change in said frame transmission scheme.

17. The computer-readable medium according to claim 16, wherein said change in said frame transmission scheme is a future change.

18. The computer-readable medium according to claim 16, further comprising:
instructions operable to cause a processor to control a minimum length of said frame buffer under consideration of said change in said frame transmission scheme.

19. An apparatus, comprising:
a control unit, configured to control a length of a frame buffer, which frame buffer is comprised in a receiver and buffers frames that are transmitted by a transmitter according to a frame transmission scheme and received at said receiver, under consideration of a change in said frame transmission scheme.

20. The apparatus according to claim 19, wherein said change in said frame transmission scheme is a future change.

21. The apparatus according to claim 19, wherein said change in said frame transmission scheme is commanded by said receiver.

22. The apparatus according to claim 19, wherein said change in said frame transmission scheme is requested by said receiver.

23. The apparatus according to claim 19, wherein a necessity of said change in said frame transmission scheme is determined by said transmitter at least partially based on measurement data provided by said receiver.

24. The apparatus according to claim 19, wherein said control unit is configured to control said length of said frame buffer by frame insertion.

25. The apparatus according to claim 19, wherein said control unit is configured to control said length of said frame buffer by causing a decoder that decodes said frames to perform time scaling.

26. The apparatus according to claim 19, wherein said control unit is further configured to control a minimum length of said frame buffer under consideration of said change in said frame transmission scheme.

27. The apparatus according to claim 26, wherein said control unit controls said minimum length of said frame buffer by changing said minimum length of said frame buffer by an amount that corresponds to a delay imposed by said change in said frame transmission scheme.

28. The apparatus according to claim 26, wherein said control unit is further configured to maintain a change of said minimum length of said frame buffer due to said control of said minimum length of said frame buffer until said frame transmission scheme has changed.

29. The apparatus according to claim 19, wherein said frame transmission scheme defines which and how many frames are transmitted in a packet of an underlying protocol layer.

30. The apparatus according to claim 19, wherein said transmission scheme is suited to define at least one of frame aggregation transmission and frame redundancy transmission.

31. The apparatus according to claim 19, wherein said frames are speech frames.

32. The apparatus according to claim 19, wherein said frames are encapsulated into real-time transport protocol frames.

33. The apparatus according to claim 19, wherein said frames are transmitted via an internet protocol-based network.

34. The apparatus according to claim 19, wherein said receiver is a multimedia telephony service over internet protocol multimedia subsystem receiver.

35. The apparatus according to claim 19, wherein said apparatus is said receiver.

36. An apparatus, comprising:
a control unit, configured to control a length of a frame buffer, which frame buffer is comprised in a multimedia telephony service over internet protocol multimedia subsystem receiver and buffers real-time transport protocol frames that are transmitted by a transmitter according to a frame transmission scheme and received at said receiver, under consideration of a change in said frame transmission scheme.

37. The apparatus according to claim 36, wherein said change in said frame transmission scheme is a future change.

38. The apparatus according to claim 36, wherein said control unit is further configured to control a minimum length of said frame buffer under consideration of said change in said frame transmission scheme.

39. An apparatus, comprising:
means for determining a length of a frame buffer,
means for controlling the length of said frame buffer, which frame buffer is comprised in a receiver and buffers frames that are transmitted by a transmitter according to a frame transmission scheme and received at said receiver, under consideration of a change in said frame transmission scheme.

40. The apparatus according to claim 39, wherein said change in said frame transmission scheme is a future change.

41. The apparatus according to claim 39, further comprising:
means for controlling a minimum length of said frame buffer under consideration of said change in said frame transmission scheme.

42. A system, comprising:
a transmitter, configured to transmit frames according to a frame transmission scheme; and
a receiver, comprising:
a frame buffer configured to buffer said frames received from said transmitter; and
a control unit configured to control a length of said frame buffer under consideration of a change in said frame transmission scheme.

43. The system according to claim 42, wherein said change in said frame transmission scheme is a future change.

44. The system according to claim 42, wherein said change in said frame transmission scheme is commanded by said receiver.

45. The system according to claim 42, wherein said change in said frame transmission scheme is requested by said receiver.

46. The system according to claim 42, wherein a necessity of said change in said frame transmission scheme is determined by said transmitter at least partially based on measurement data provided by said receiver.

47. The system according to claim 42, wherein said control unit of said receiver is further configured to control a minimum length of said frame buffer under consideration of said change in said frame transmission scheme.
